(19) United States
(12) Patent Application Publication
(10) Pub. No.: US 2010/0263167 A1
(43) Pub. Date: Oct. 21, 2010

(54) Counter-balance apparatus and method for providing a stabilizing force

(76) Inventor: Seymour Ian Fox, Palm Beach Gardens, FL (US)

Correspondence Address: Seymour Ian Fox, 394 Isle Court, Palm Beach Gardens, FL, 33418, US

(21) Appl. No.: 12/386,311

(22) Filed: Apr. 16, 2009

(51) Int. Cl. F16F 15/28

(52) U.S. Cl. 16/400

(57) ABSTRACT

A counter-balance apparatus and method, including configurable weights, suspensions, and supports, upon which an external force can be exerted, and as a result, will react as a counter-balance to said external force as a means to provide force resistance and stability; wherein the construct may be encapsulated, varied in materials, size, and substance, enabling said counter-balance with a predictable and known effect to be produced at scale, readily installed, moved, or manipulated, to address a plethora of stabilization applications, and which further comprises fastener(s) and/or band(s) to secure it to immobile, mobile, or in-motion objects, and computational and communications capabilities to dynamically adjust to external factors.

### FIELD OF THE INVENTION

The present invention pertains to a counter-balance apparatus and method for providing a stabilizing force, and in particular, the present invention pertains to a counter-balance apparatus and method for providing stabilizing force, which provides enhanced products and/or services for engineering, architectural, medical, vehicle, athletic, and other industries and individuals who or which utilize same.

### BACKGROUND OF THE INVENTION

Stability is one of the most fundamental challenges facing engineers, architects, and athletes when seeking to mitigate the directional forces that may cause an object or individual to lose steadiness when encountering external forces or forces of motion. Ever greater engineering and architectural developments, as well as athletic innovations, have severely tested the limits of mechanical, materials, design, and information technology engineering in this regard. The ability to readily, simply, and predictably improve stability can lead to the development of products and services in the United States and throughout the rest of the world that would benefit industry and individuals. Throughout past centuries, innovations in stabilizing technologies have enabled the founding and growth of industries and improved lives of individuals due to the ability to mitigate unwanted and/or dangerous forces acting upon an object such as buildings and/or individuals.

In spite of the fact that stability has for centuries been a challenge for engineers, architects, and athletes, current counter-balance systems have many shortcomings in an age when engineers, architects, and athletes demand innovative, effective, commercially viable mechanisms to be more efficient and effective.

Typically, engineers, architects, and athletes have to rely on customized designs for nearly every application for which a counter-balance is needed. Today, this often this requires significant development and testing with expensive computer modeling technologies as well as trial-and-error prototyping. For example, today's builders of towers and buildings have to custom design a counter-balance apparatus to affect stability in the structure. This requires significant time and cost in the production of the structure. For safety reasons stability is an essential design factor that cannot be overlooked. The ability to apply a readily available, pre-constructed, pre-calculated, counterbalance system with a predicable effect would make the benefits of stability more widely available to builders of structures, systems, devices, and products. The result being that many more people would benefit from improved safety and performance of these structures, systems, devices, and products.

The inefficiencies associated with the current systems for providing stabilizing systems to structures, systems, devices, and products may be characterized by complexity of design and the need for extensive customization of stability solutions, time to develop customized stability solutions and to deploy such stability solutions, cost of such complex and customized stability solutions, and thus limited accessibility of stability solutions to those who may benefit most from them. By creating a mechanism with known stabilization effects in a construct that can be readily implemented in a plethora of applications will enable the benefits of stabilization to be achieved by many more individuals in the structures, systems, devices, and products they use. The net benefit would accrue in terms of safety, performance, cost, and time.

### SUMMARY OF THE INVENTION

The present invention pertains to a counter-balance apparatus and method for providing stabilizing effects that overcomes the shortcomings of the prior art. The present invention pertains to a counter-balance apparatus and method for providing stabilizing effects, which provides enhanced products and/or services for engineers, architects, designers, athletes, and others who or which utilize same.

The present invention provides an apparatus and method of use by which counter-balance can be effectuated in a self-contained unit with pre-determined and/or pre-calculated and predictable effects.

The present invention is intended to perform as a counter-balance so as to create an opposite directional force to counter act the effects of an external force acting upon the counter-balance, and/or any structure to which the counter-balance may be fixed, with the resulting effect being stabilization.

The present invention may be utilized to provide a comprehensive counter-balance for the very many types of engineering, architectural, design, medical, and athletic products, services, and constructions.

Such types of engineering, architectural, design, medical, and athletic products, services, and constructions may include, but are not limited to, edifices, systems, conduits, vehicles, particles, equipment, devices, apparel, gear, prosthetics, compositions, atoms, molecules, structures, and materials.

The present invention may be utilized as either a fixed apparatus and/or a free-motion apparatus. Equally it may be constructed in various materials, sizes, weights, shapes, motion paths, suspensions and/or support configurations in order to enable a multitude of counter-balance force effects. Moreover, the materials used in construction may vary in order to ensure that a certain type of construction is best suited for certain types of purposes.

The present invention may be constructed as an apparatus that is intended to function in a state whereby its position is fastened to a second structure, wherein that second structure may be either immobile with a fixed position as in the case of but not limited to a building, or conversely moveable as in the case of but not limited to a vehicle. The present invention may also be constructed as an apparatus that is intended to function in a state whereby its position is not fixed to any structure, but rather is free moving and may have its position changed at any moment based upon external forces acting upon it as in the case of but not limited to a hand-held counter-balance.

The present invention may be constructed as an apparatus in various sizes to in order to enable a multitude of uses. By example, the device may be constructed at the particle level, atomic level or molecular in order to affect the movement and effects of external forces on sub-atomic structures, atomic structures, and/or molecular structures as might appear in nano devices. Or, it may be the case that the apparatus and method are configured on the very small visible scale to be placed in other manufactured goods or structures such as but not limited to a sub-strata element, or applied coating. Or, it may be the case that the apparatus and method are configured on the scale in which the human body might interact directly with the apparatus, such as the case might be with a counter-balance used by athletes either in the instance where it is fixed in or to another piece of athletic equipment and/or held freely in the hands. Or, it may be the case that the apparatus and method are configured on the medium-to-large scale in which a vehicle may have the counter-balance fixed within and/or to its structure. Or, it may be the case that the apparatus and method are configured on the large scale in which a large building, tower, or bridge may have the counter-balance and/or multiple-counter balances fixed to and/or assembled within its construction.

The present invention may be constructed as an apparatus with varying volumes in order to effectuate a multitude of counter-balance effects, such as but not limited to its counter-balance effects in various mediums such as liquids, gases, plasmas, or solids. Or, it may be the case that the apparatus and method are configured in a manner that permits reactive, proactive, or dynamic changes to its volume.

The present invention may be constructed as an apparatus with varying weights, mass, or weight to volume ratios, or weighting configurations, or mass to volume ratios, or mass configurations, in order to effectuate a multitude of counter-balance effects, such as but not limited to its counter-balance effects at various altitudes and/or suspensions, and/or environments of varying densities. Or, it may be the case that the apparatus and method are configured in a manner that permits reactive, proactive, or dynamic changes to its weight.

The present invention may be constructed as an apparatus with various suspension and/or support configurations in order to effectuate a multitude of counter-balance effects, such as but not limited to its counter-balance effects in response to varying directional forces and/or motion paths. Or, it may be the case that the apparatus and method are configured in a manner that permits reactive, proactive, or dynamic changes to its various suspension and/or support configurations.

The present invention may be constructed as an apparatus with various intended motion paths and/or intentionally random motion paths in order to effectuate a multitude of counter-balance effects, such as but not limited to its counter-balance effects in response to external forces that may be encountered at predetermined and/or random intervals. Or, it may be the case that the apparatus and method are configured in a manner that permits reactive, proactive, or dynamic changes to its motion path, paths, and or intentionally random motion paths.

The present invention may be constructed as an apparatus with various materials in order to effectuate a multitude of counter-balance effects, such as but not limited to its counter-balance effects in response to external forces that may be encountered at in response to a variety of substances and/or energies such as but not limited to various levels of friction, viscosity, electromagnetism, heat, light, radiation, forces of energy, inertia, forces of motion, and/or gravity. Or, it may be the case that the apparatus and method are configured in a manner that permits reactive, proactive, or dynamic changes to its materials.

The present invention may be constructed as an apparatus composed of multiple counter-balances acting either in concert and/or independently in order to effectuate a multitude of counter-balance effects, such as but not limited to its counter-balance effects in flexible materials, coatings, substrates, laminates, garments, devices, equipment, machines, edifices, and/or vehicles. Or, it may be the case that the apparatus and method are configured in a manner that permits reactive, proactive, or dynamic changes to its numbers of instances of occurrence.

The present invention may be constructed as an apparatus with the ability to make changes and/or augment any one of the physical parameters that would alter the effect of the counter-balance such as but not limited to material, size, volume, weight, suspension and/or support configurations, motion paths, and/or quantities, and/or any ratios of two or more of such variables. Or, it may be the case that the apparatus and method are configured in a manner that permits reactive, proactive, or dynamic changes to such physical parameters.

### BRIEF DESCRIPTION OF THE DRAWINGS

In the Drawings:

FIG. 1 illustrates the apparatus of the present invention, in mechanical functional diagram form from a cross-sectional view;

FIG. 2 illustrates the apparatus of the present invention, in mechanical functional diagram form from a force path view;

FIG. 3 illustrates the apparatus of the present invention, in mechanical functional diagram form from a multi-direction support/suspension view;

FIG. 4 illustrates the apparatus of the present invention, in mechanical functional diagram form from a suspended three-dimensional view;

FIG. 5 illustrates the apparatus of the present invention, in mechanical functional diagram form from a fixed/mounted-to-structure view;

FIG. 6 illustrates the apparatus of the present invention, in mechanical functional diagram form from a free-standing view;

FIG. 7 illustrates a preferred embodiment operation of the apparatus of FIG. 1, in a flow diagram form;

FIG. 8 illustrates yet another preferred embodiment operation of the apparatus of FIG. 1, in a flow diagram form; and

FIG. 9 illustrates yet another preferred embodiment operation of the apparatus of FIG. 1, in a flow diagram form.

### DESCRIPTION OF THE PREFERRED EMBODIMENTS

The present invention pertains to a counter-balance apparatus and method for providing stabilizing effects that overcomes the shortcomings of the prior art. The present invention pertains to a counter-balance apparatus and method for providing stabilizing effects, which provides enhanced products and/or services for engineers, architects, designers, athletes, and others who or which utilize same.

The apparatus and method of the present invention, in a preferred embodiment, provides a system and/or platform to perform as a counter-balance so as to create an opposite directional force to counter act the effects of an external force acting upon the counter-balance, and/or any structure to which the counter-balance may be fixed, with the resulting effect being stabilization.

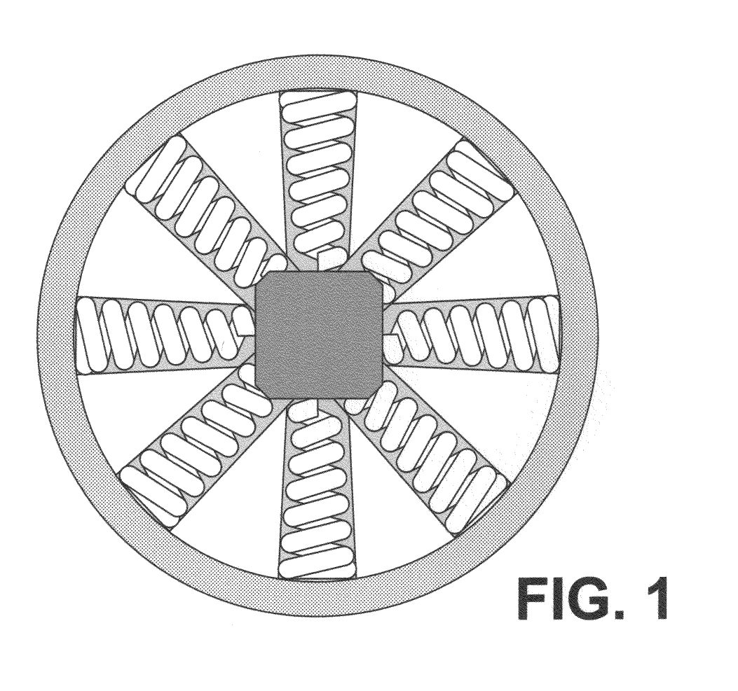

FIG. 1 (“Cross Section View”) illustrates a preferred embodiment of the apparatus of the present invention, by example, wherein a centered weight(s) is/are suspended/supported by springs, encased springs, spring-like, or cushioning material, or any such suspension or support mechanism that may be enclosed in a casing, upon which force can be exerted as a counter-balance to a directional force.

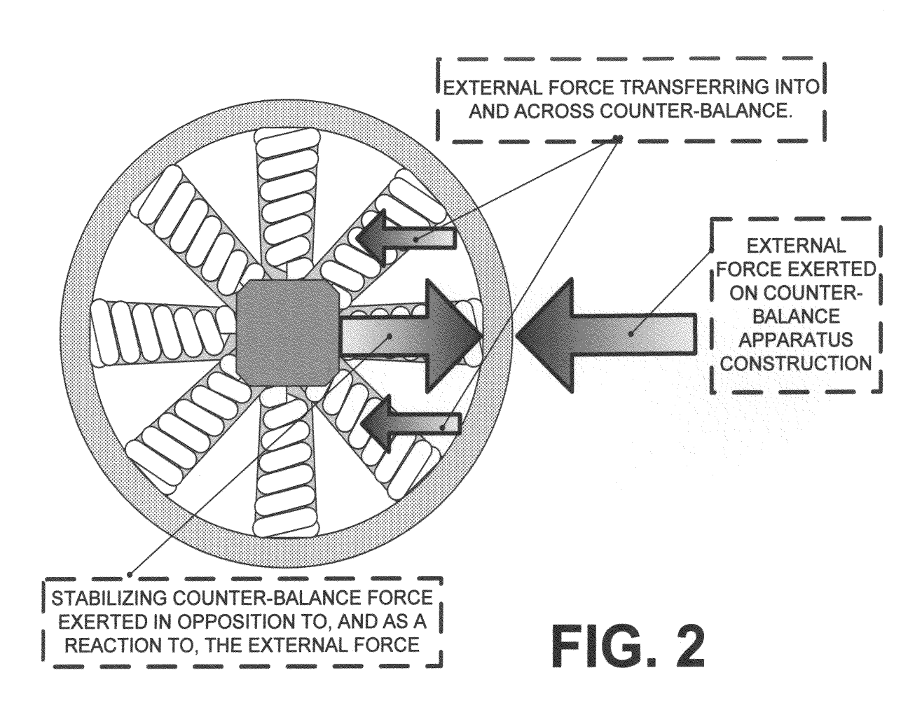

FIG. 2 (“Force Path View”) illustrates a preferred embodiment of the apparatus of the present invention, by example, wherein a centered weight(s) is/are suspended/supported by springs, encased springs, spring-like, or cushioning material, or any such suspension or support mechanism that may be enclosed in a casing, upon which force can be exerted as a counter-balance to a directional force.

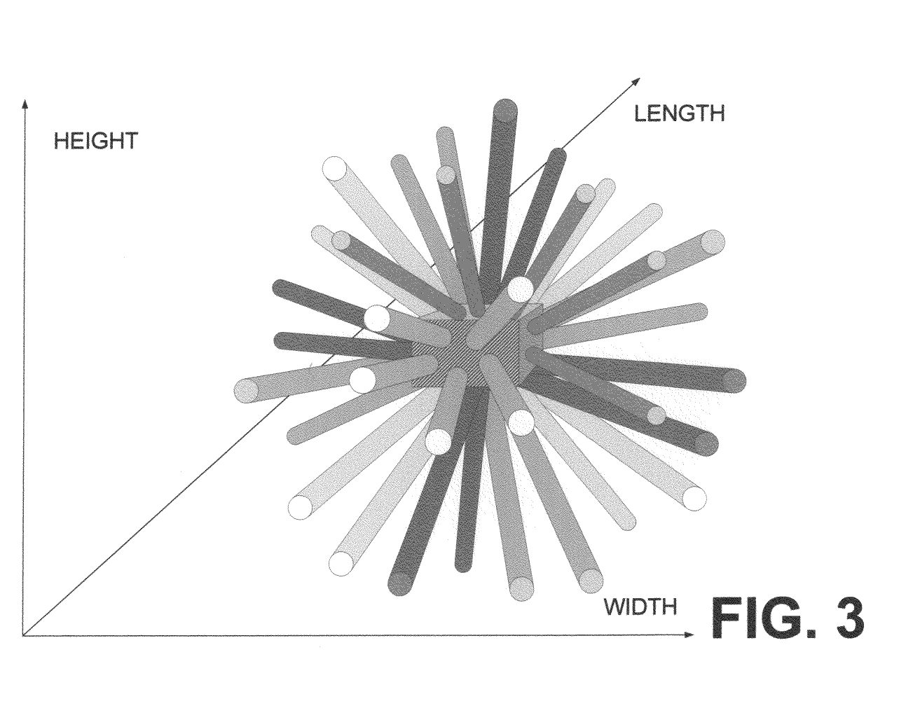

FIG. 3 (“Multi-Direction Support/Suspension View”) illustrates a preferred embodiment of the apparatus of the present invention, by example, wherein the counterbalance weight(s) is/are supported/suspended by/with springs, encased springs, spring-like, or cushioning material, or any such suspension or support mechanism that may be enclosed in a casing, in all/many directions, thus creating a counter-balance against directional force effective in all/many directions.

In a preferred embodiment, the present invention provides an apparatus and method of use by which counter-balance can be effectuated in a self-contained unit with pre-determined and/or pre-calculated and predictable effects.

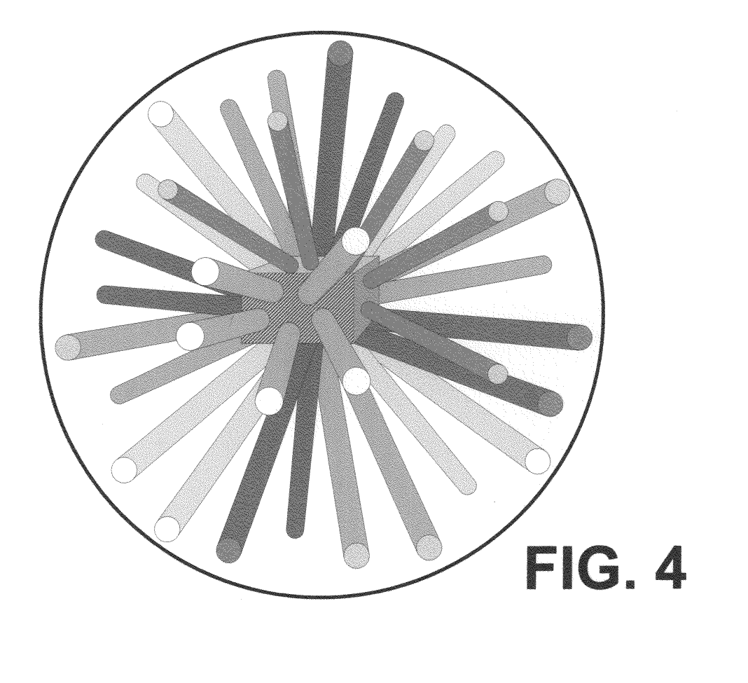

FIG. 4 (“Suspended 3-Dimentional View”) illustrates a preferred embodiment of the apparatus of the present invention, by example, wherein a centered weight(s) is/are suspended/supported by/with springs, encased springs, spring-like, or cushioning material, or any such suspension or support mechanism that may be enclosed in a casing, and enclosed in a capsule upon which force can be exerted. This enables the counter-balance to be quickly installed or moved, and ensures a predictable and known effect.

In this manner, the apparatus and method of the present invention can be utilized, in a preferred embodiment, to provide a comprehensive counter-balance for the very many types of engineering, architectural, medical, athletic, design, structures, platforms, and services such as; industrial buildings, commercial buildings, residential buildings, suspended structures, cabling, towers, bridges, tunnels, bypasses, conduits, thoroughfares, roads, escalators, elevators, cable cars, gondolas, sea-platforms, suspended structures, abbeys, priories, amphitheatres, pyramids, arches, archways, ducts, thoroughfares, highways, thruways, roads, pipes, pipelines, platforms, elevators, escalators, aqueducts, aquaria, archaeological sites, basilicas, bridges, casinos, castles, cathedrals, churches, performance halls, theaters, movie theaters, concert halls, dams, fortifications, forts, bunkers, garrisons, shelters, caves, caverns, tunnels, temples, apartments, warehouses, commercial premises, industrial premises, platforms, sea platforms, space platforms, drilling platforms, space stations, houses, hospitals, outdoor arenas, indoor arenas, clubs, lighthouses, masts, mosques, museums, particle accelerators, nuclear reactors, observatories, opera houses, palaces, castles, solar buildings, prisons, shrines, stadiums, synagogues, structures, buildings, temples, towers, walls, windmills, balconies, terraces, suspended structures, supported structures, and/or suspended and supported structures.

Furthermore, the apparatus and method of the present invention can be utilized, in a preferred embodiment, to provide a comprehensive counter-balance for the very many types of equipment, apparatus, edifices, machinery, facilities, and/or components, and materials utilized in engineering, architecture, designs, structures and platforms, and services such as, but not limited to; power generation, wind energy structures, wave energy structures, tide energy structures, energy wave structures, power generation, wind power, hydro-electric power generation, wave power generation, tide power generation, chemical power generation, nuclear power generation, gravitational power transference, gravitational power generation, particle power generation, sub-atomic particle power generation, electric power generation, kinetic energy generation, potential energy generation, thermal energy generation, electric energy generation, wave power generation, magnetic power generation, electro-magnetic power generation, steam power generation, combustion power generation, power creation structures, energy capture structures, energy transference structures, energy consumption structures, wind energy structures, wave energy structures, tide energy structures.

Moreover, the apparatus and method of the present invention can be utilized, in a preferred embodiment, to provide a comprehensive counter-balance for the very many types of equipment, machinery, facilities, and/or components, and materials utilized in engineering, power generation, architecture, designs, structures and platforms, and services such as, but not limited to; wind energy structures, wave energy structures, tide energy structures, energy wave structures, cases, cages, containers, crucibles, casts, moulds, pallets, bags, totes, suitcases, pull carts, push carts, trolleys, cranes, rigs, drills, panels, solar panels, chimneys, antenna, receivers, transmitters, signaling devices, communications devices, displays, computers, information technology hardware, systems, routers, hubs, chips, assemblies, components, connectors, cabling, loads, supports, suspensions, stabilizers, lifters, loaders, movers, diggers, forklifts, robots, assembly systems, tanks, pools, domes, mirrors, girders, structural systems, turbines, motors, machines, jets, compressors, accelerators, decelerators, hammers, axes, pliers, screw drivers, wrenches, tools, construction tools, demolition tools, boring machines, mixers, separators, presses, rollers, belts, cables, ropes, wires, conveyor systems, conveyor belts, carriers, reactors, diffusers, mechanical systems, constructions, devices, construction equipment, aerial work platform, lift table, air-track, agricultural tractors, articulated hauler, articulated truck, asphalt paver, asphalt plant, backhoe loader, backhoe, boomtruck, bulldozer, cherry picker, cold planer, combat engineering vehicle, compact excavator, concrete batch plant, construction and mining tractor, construction and mining trucks, crane, cure rig, dragline excavator, dredging, drilling machine, excavator (wheel), excavator (bagger, digger), feller buncher, forklift truck, forklift, fresno scraper, front shovel, harvester, highway ten yard rear dump, highway bottom dump, pup (belly train), triple, highway end dump and side dump, highway transfer, transfer train, highway transit-mixer, knuckleboom loader (trailer mount), motor grader, pile driver, pipelayer, pneumatic drill, pneumatic machinery, pneumatic tire compactor, compactor, reclaimer, soil stabilizer, roadheader, roller (road roller, roller compactor), rotary tiller (rototiller, rotovator), scraper, skid steer loader, skidder, skip loader, slipform paver, steam shovel, stomper, street sweeper, telescopic handlers, track harvester, track loader, track skidder, track-type tractors and bulldozers, tractor, trencher, tunnel boring machine, underground mining equipment, venturi-mixer, vibratory compactor, water wagon, wheel dozers, soil compactors, wheel forwarder, wheel loader, front loader, integrated tool carrier, wheel skidder, wheel tractor-scraper, yarder, backhoe, thumb, hydraulic hammer, hoe ram, vibratory plate compactor, demolition shears, sheeps foot compactor, clam shell bucket, pile driver, grapple, excavator bucket, equipment bucket, pavement removal bucket, skeleton bucket, hydraulic tilting bucket, material handling arm, forks, hydraulics, cold plane, multi processor, broom, power take-off, quick coupler, rake, ripper, bulldozer blade, landscape tiller, mechanical pulverizer, crusher, rotating grab, snow blower, stump grinder, stump shear, auger, tiltrotator, trencher, bale spear, wheel saw, and/or but not limited to materials, and/or construction materials, building materials, acoustics, acoustic panels, sealers, air conditioning systems and components, heating systems and components, ventilation systems and components, plumbing systems and components, communications systems and components, computing systems and components, electric systems and components, energy systems and components, cells, solar cells, blades, windmills, generators, turbines, pumps, fins, flow controllers, flow regulators, measurement devices, current/flow/wind/water/liquid/gas energy production and/or transportation systems, grids, conduits, brick, power systems, transportation systems, natural materials, fabric, mud and clay, rock, thatch, brush, ice, wood, brick, block, concrete, cement, metal, glass, ceramics, plastics, foam, cement composites, cladding, dimensional lumber, drainage, electrical equipment, enviroboard, fire protection equipment, fireproofing equipment, framing, glazing, hoisting, pumps, ventilation, air-conditioning, insulation, joinery, lighting, masonry, millwork, mortar, paint, sealer, primer, penetrant, plaster, plaster board, sheetrock, equipment and systems for plumbing, power trowel, rigging, roads, stone, roof, roof edge, sediment, septic tank, sewerage treatment facility, shear wall, shoring, solar cells, storm drain, stainless steel, straw-bales, telephone equipment, fencing, tilt slab, timber, timber framing, toilets, floors, walls, windows, doors, ceilings, roofs, water, plastics, glass, wood, stone, metals, minerals, man-made materials, alloys, water, solids, liquids, gasses, plasmas, fibers, chemicals, chemical bonds, adhesives, ropes, straps, tapes, bonding agents, screws, nuts, bolts, nails, latches, hinges, clasps, hooks, holders, fixers, washers, joiners, frames, inserts, couplers, sockets, wires, conduits, casings, encasements, beams, supports, and suspensions.

The apparatus and method of the present invention can be utilized, in a preferred embodiment, to provide a comprehensive counter-balance for the very many types of vehicles utilized in the practice of, but not limited to, transportation, engineering, science, logistics, sports, defense, surveillance, and platforms, and services such as, but not limited to; land vehicles, trains, trucks, buses, trolleys, trams, motorcycles, bicycles, scooters, rollers, carts, air vehicles, planes, gliders, paragliders, parachutes, parasails, hang-gliders, marine vehicles, ships, boats, rafts, water sports devices, wave-runners, jet skis, unicycles, bicycles, tricycles, quadricycle, velomobile, electric road carriages, steam road carriage, steam vehicles, motor cars, petroleum motor-carriages, road trains, motorcycles, rail-vehicles, road vehicles, water vehicles, under-water vehicles, land and water vehicles, snow vehicles, air vehicles, mechanical vehicles, aircraft, amphibious vehicles, articulated vehicles, automobiles, bivalent vehicles, emergency vehicles, engineering vehicles, experimental vehicles, green vehicles, human-powered vehicles, jet cars, kit vehicles, military vehicles, motorcycles, off-road vehicles, phantom vehicles, propulsion vehicles, racing vehicles, rail vehicles, recreational vehicles, road vehicles, rockets and missiles, spacecraft, space shuttles, satellites, three-wheeled motor vehicles, toy cars and trucks, toy vehicles, tracked vehicles, wheeled vehicles, belt vehicles, trailers, unmanned vehicles, walking vehicles, robots, unmanned vehicles, remote controlled vehicles, automatically piloted vehicles, projectiles, explosives, waste collection vehicles, watercraft, strollers, advanced technology vehicles, amphibious vehicle, articulated vehicle, automobile, baby transport, bookmobile, tanks, humvee, bronetransporter, bumper car, compressed hydrogen tube trailer, crossover automobile, dicycle, Segway, dual-mode vehicle, electric motorcycles and scooters, first call vehicle, hearse, heritage vehicles, ice resurfacer, Zamboni, liquid hydrogen tanktainer, liquid hydrogen trailer, luton body, mail truck, mobile laboratory, motor vehicle, off-highway vehicle, off-road transport, personal rapid transit, rail car mover, revopak, garbage truck, road-rail vehicle, rotopress, screw propelled vehicle, sea tractor, side by side (UTV), single-occupant vehicle, three wheeler, trackless train, traction engine, urban light transport (ULTra), utility vehicle, zero-emissions vehicles, land vehicles, trains, trucks, buses, trolleys, trams, motorcycles, bicycles, scooters, rollers, carts, air vehicles, planes, gliders, paragliders, parachutes, parasails, hang-gliders, marine vehicles, ships, boats, submarines, rafts, water sports devices, wave-runners, jet skis, manned vehicles, unmanned vehicles, programmed vehicles, remote controlled vehicles,

The apparatus and method of the present invention can be utilized, in a preferred embodiment, to provide a comprehensive counter-balance for the very many types of athletic products, platforms, services, and equipment such as, but not limited to, those handheld, attached to the body, worn, stationary, mounted, fixed, imbedded, coupled, linked, working in conjunction with another object and/or being utilized by an individual being, and/or by another mechanical device or devices, and/or in association with a vehicle or vehicles, in a manner that could be described as supporting, suspending, and/or other athletic equipment such as, but not limited to, helmets, gloves, braces, bands, covers, surfaces, shoes, apparel, weights, weighted devices, resistance devices, isometric exercise equipment, exercise devices, support devices, walking devices, sticks, poles, weights, balances, fitness equipment, gymnastics equipment, sports apparatus, athletic gear, athletic apparel, training equipment, punching bags, kicking bags, striking devices, clubs, balls, floats, floating devices, buoys, compasses, goals, nets, markers, weight devices, resistance devices, support devices, walking devices, jogging devices, running devices, motion devices, objects of play for sport, objects of play, objects for recreation, exercise equipment, jogging devices, running devices, motion devices, or equipment or sporting devices for any of the following, but not limited to, air sports, space sports, land sports, water sports, underwater sports, including, but not limited to, bandy, baseball, billiard sports, boules, bowling, kagel, bridge, chess, boxing, climbing, cricket, dance, dance sport, golf, polo, lawn darts, darts, croquet, gymnastics, balance, jump ropes, gloves, shoes, soles, liners, cushioning, boots, pants, shirts, shorts, headgear, pads, crops, braces, balls, bowling balls, bowling pins, pucks, floats, levers, bats, sticks, striking devices, bags, weighted bags, catching devices, throwing devices, volleying devices, padding, mats, cushioning, martial arts, karate, korfball, swimming, diving, lifesaving, motorsports, motorcycle sport, netball, orienteering, pelote basque, powerboating, marine sports, aquamarine sports, power marine sports, marine vehicle sports, air vehicle sports, land vehicle sports, space vehicle sports, racquet sports, ball sports, racquetball, wheeled sports, roller sports, rugby, softball, squash, fighting sports, boxing, sumo, wrestling, surfing, tug of war, underwater sports, underwater vehicle sports, water skiing, skiing, snow skiing, air skiing, wushu, american football, australian rules football, ballooning, gliding, bowling, boules, budo, finnish baseball, glima, gliding, kaatsen, korfball, la canne, surf lifesaving, longue paume, motorsport, roller hockey, ice hockey, hockey, field hockey, savate, swedish (Ling) gymnastics, weight lifting, weight training with dumbbells, barbells, weights, isometrics, resistance exercise, powerlifting, water skiing, diving, swimming, synchronized swimming, water polo, archery, track and field sports, athletics, yoga, stepping, pilates, badminton, basketball, boxing, canoe, cayak, flatwater canoe/kayak, slalom canoe/kayak, unicycle, bicycle, tricycle, BMX, mountain biking, road cycling, track cycling, equestrian, fencing field hockey, soccer, football, gymnastics (artistic, rhythmic, trampoline, handball, judo, modern pentathlon, rowing, sailing, shooting, tennis, table tennis, taekwondo, triathlon volleyball, beach volleyball, indoor volleyball, weightlifting, wrestling, baseball, basque pelota, jai alai, cricket, croquet, skating, figure skating, golf, ice hockey, jeu de paumel, lacrosse, roque, rugby, softball, tug of war, water motorsports, biathlon, bobsleigh, skeleton, curling, ice hockey, luge, short track speed skating, speed, alpine skiing, cross country skiing, freestyle skiing, nordic combined, ski jumping, snowboarding, bandy, ice stock sport, freestyle BMX, supermoto, supercross, skateboarding, snowmobile, wave runner, jetski, kites, kite surfing, snocross, monoski, in-line skating, bungee jumping, wakeboarding, sport climbing, bouldering, skysurfing, street luge, snowmobiling, skiing, BMX, kayaking, moto cross, mountain biking, rock climbing, skateboarding, surfing, wakeboarding, deaf sports, blind sports, alpine skiing, athletics, badminton, basketball, beach volleyball, bowling, cross-country skiing, curling, cycling, cricket, football, handball, ice hockey, judo, karate, orienteering, shooting, snowboard, skibob, swimming, table tennis, tae kwon do, tennis, volleyball, water polo, wrestling, paralympic sports, archery, shooting, boccia, bowls, cue sports, goalball, ice sledge hockey, ice sledge racing, bowling, nine-pin bowling, ten-pin bowling, torball, aquatics, floor hockey, short track speed skating, team handball, handcycling, and fitness training for sport including stationary and mobile equipment for practicing, training, or participating in, but not limited to, the aforementioned. Moreover, another preferred embodiment of the present invention would be utilized in spectator sports such as, but not limited to, horse racing, dog racing, animal racing, vehicle racing, and the equipment utilized by the person, being, and/or animal, either directly or in conjunction with the performance of the activity and/or sport.

Moreover, another preferred embodiment of the present invention would be utilized in weapons such as, but not limited to, knives, spears, blades, multi-bladed devices, spring-loaded devices, guns, missiles, rockets, warheads, bullets, projectiles, detonators, explosives, mines, bombs, casings, fuses, switches, remote controllers, shot, shot guns, rifles, launchers, bazookas, howitzers, guns, firearms, pistols, revolvers, handguns, sprays, nets, covers, perimeter security devices, biological agent deployment devices, chemical agent deployment devices, nuclear agent deployment devices, electricity deployment devices, laser deployment devices, heat deployment devices, sound deployment devices, energy deployment devices, stun-guns, sticks, clubs, striking weapons, catching weapons, twisting weapons, pushing weapons, pulling weapons, poking weapons, cutting weapons, restraining devices, handcuffs, leg-irons, covering devices, securing devices, and/or devices that can be used as and/or for effecting the damage and/or impairment and/or restraint of another object.

In a preferred embodiment, the apparatus and method of the present invention can be utilized to provide a comprehensive counter-balance for the very many types of engineering and medical designs, structures and platforms, and services such as, but not limited to, physical therapy apparatuses, medical care products, support apparel, support hose, prosthetics, implanted devices, inserted in fluids, inserted internally to the body in fluids, muscle, bone, ligaments, cartilage, tendons, tissue, and/or as implants, artificial limbs, artificial joints, artificial body parts, artificial body fluids, artificial muscles, artificial tissue, artificial ligaments, artificial organs, replacement limbs, replacement joints, replacement body parts, replacement body fluids, replacement muscles, replacement ligaments, replacement organs, joint replacements, bone plates, bone cement, artificial ligaments and/or tendons, dental implants for tooth fixation, blood vessel prostheses, heart valves, skin repair devices, cochlear replacements, contact lenses, wheelchairs, braces, suspensions, supports, massage devices, wheelchairs, braces, handles, rims, edges, knobs, buttons, snaps, straps, buckles, adhesives, tapes, ropes, velcro, ties, laces, joiners, extensions, springs, hoists, cushions, balances, supports, suspensions and the like.

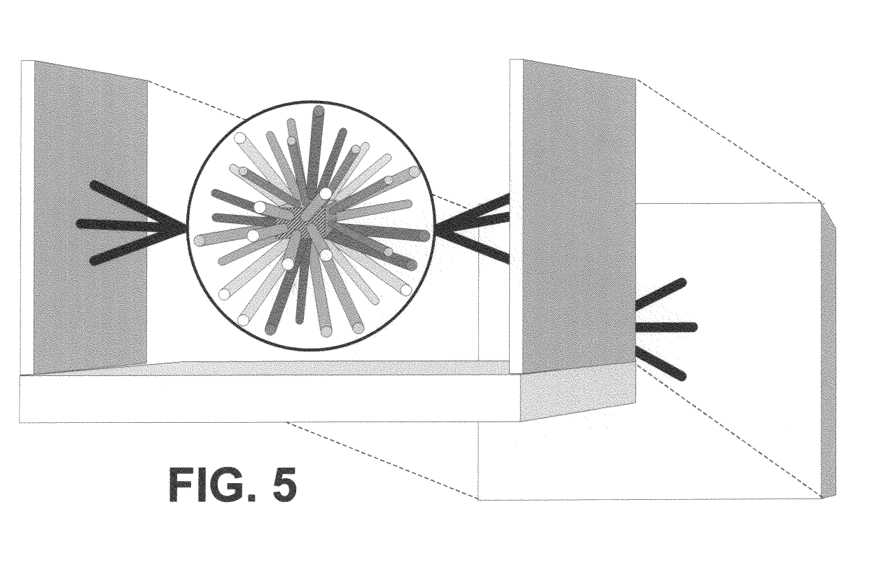

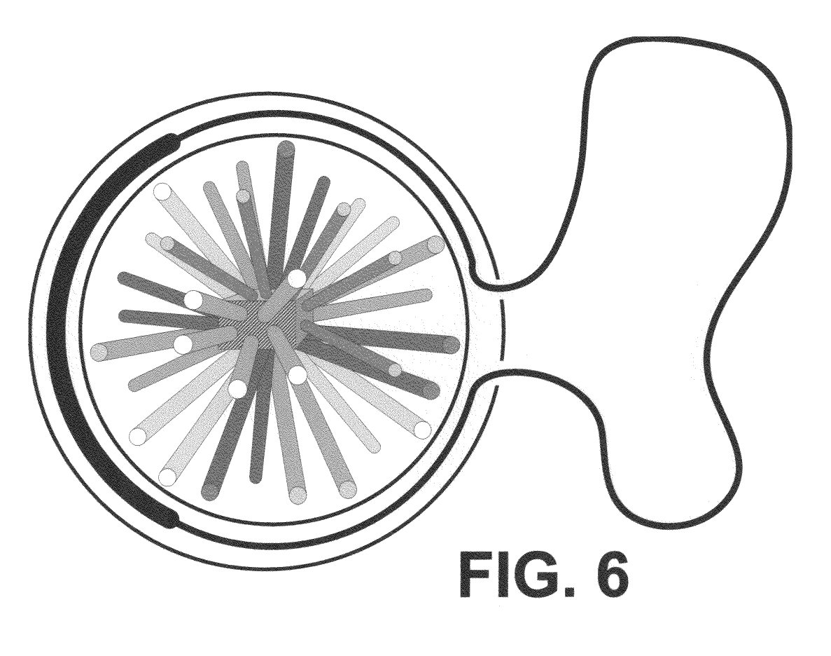

In a preferred embodiment, the present invention may be utilized as either a fixed apparatus and/or a free-motion apparatus. As such, the present invention may be constructed as an apparatus that is intended to function in a state whereby its position is fastened to a second structure, wherein that second structure may be either immobile with a fixed position as in the case of but not limited to a building, or conversely moveable as in the case of but not limited to a vehicle. The present invention may also be constructed as an apparatus that is intended to function in a state whereby its position is not fixed to any structure, but rather is free moving and may have its position changed at any moment based upon external forces acting upon it as in the case of but not limited to a hand-held counter-balance. FIG. 5 (“Mounted To Structure View”) illustrates a preferred embodiment of the apparatus of the present invention, by example, in conjunction with a fixed apparatus, where FIG. 6 (“Free-Standing View”) illustrates a preferred embodiment of the apparatus of the present invention, by example, the implementation of the free-motion apparatus.

FIG. 5, (“Mounted To Structure View”), illustrates a preferred embodiment of the apparatus of the present invention, by example, wherein a centered weight(s) is/are suspended/supported by/with springs, encased springs, spring-like, or cushioning material (that may be enclosed in a casing) and enclosed in a capsule upon which force can be exerted. The counter-balance capsule is then mounted with fixed supports to a structure which requires the benefits of stabilization.

FIG. 6, (“Free-Standing View”), illustrates a preferred embodiment of the apparatus of the present invention, by example, wherein a weight(s) is/are suspended/supported by/with springs, encased springs, spring-like, or cushioning material (that may be enclosed in a casing) and enclosed in a capsule upon which force can be exerted, wherein the counter-balance capsule may be, but must not be, further augmented with a support band mounted to the wall of the casing and wrapping the counter-balance. Moreover, the preferred embodiment of the apparatus illustrated in FIG. 6 may, or may not, employ a functional outer casing to further secure the entire structure, wherein a band, strap, tether, and/or other securing means may be employed in conjunction with the support capsule and/or outer casing to allow for controlling and/or securing the counter balance to an object of free-motion. The preferred embodiment of the apparatus in FIG. 6 is free-standing, in that it may interact with a second object that would benefit from stabilization effects, wherein the second object may be in free-motion, such as, but not limited to, a human being, an animal, a plant, a bacteria, an organism, a liquid, a solid, a plasma, a gas, a mist, an object, including, but not limited to being held, rolled, worn, sat upon, driven, thrown, hit, caught, kicked, struck, launched, catapulted, submerged, stacked, falling, ejected, shot, launched, dropped, lifted, raised, expelled, forced, carried, and/or manipulated, acted upon, and/or reacts to an internal or external forces in such a manner that it position is affected.

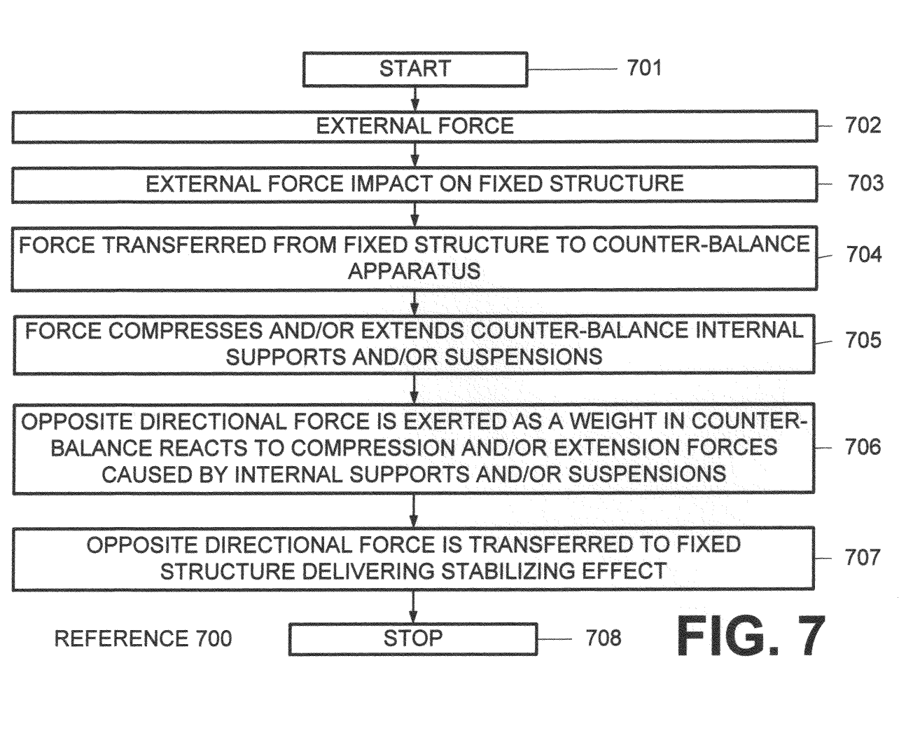

FIG. 7 illustrates a preferred embodiment of the apparatus and method of the present invention, which is designated generally by the reference number 700, in flow diagram form. With reference to FIG. 7, the apparatus and method 700 includes a starting point, 701, (hereinafter “Start 701”). The “Start 701” denotes the presence of any and/or all of the various parameters, conditions, substances, environments, and/or events for providing the various functionalities, operations, and/or services described herein as being provided by the apparatus 700. With reference to FIG. 7, the apparatus and method 700 includes the presence and/or action of an external force, 702, (hereinafter “External Force 702”). “External Force 702” denotes an external force existing externally either to the counter-balance, and/or the counter-balance in association with a fixed object. With reference to FIG. 7, the apparatus and method 700 includes an amount of an external force applied the counter-balance, and/or the counter-balance in association with a fixed object, 703, (hereinafter “External Impact 703”). Wherein the preferred embodiment of the apparatus and method of the present invention may or may not, depending on the application and/or construction, have the subject fixed object and the counter-balance existing as a unified and/or integrated structure. With reference to FIG. 7, the apparatus and method 700 includes an amount of an external force transferred to the counter-balance, and/or the counter-balance in association with a fixed object, 704, (hereinafter “Transfer Force 704”. With reference to FIG. 7, the apparatus and method 700 includes an amount of an external force transferred to the counter-balance and effecting a compression and/or extension of supports and/or suspensions of the counter-balance, 705, (hereinafter “Compression and/or Extension 705”. With reference to FIG. 7, the apparatus and method 700 includes an amount of force associated with compression and or extension effects an opposing force from the weight and/or weights contained in the counter-balance on the supports and/or suspensions of the counter-balance, 706, (hereinafter “Opposing Compression and/or Extension 706”). With reference to FIG. 7, the apparatus and method 700 includes an amount of force transferred from the counter-balance to a fixed object, 707, (hereinafter “Stabilizing Force 707”. With reference to FIG. 7, the apparatus and method 700 includes a finish point, 708, (hereinafter “Stop 708”). The “Stop 708” denotes the improved stabilized state of the object that is subject to the stabilization effects of the counter-balance.

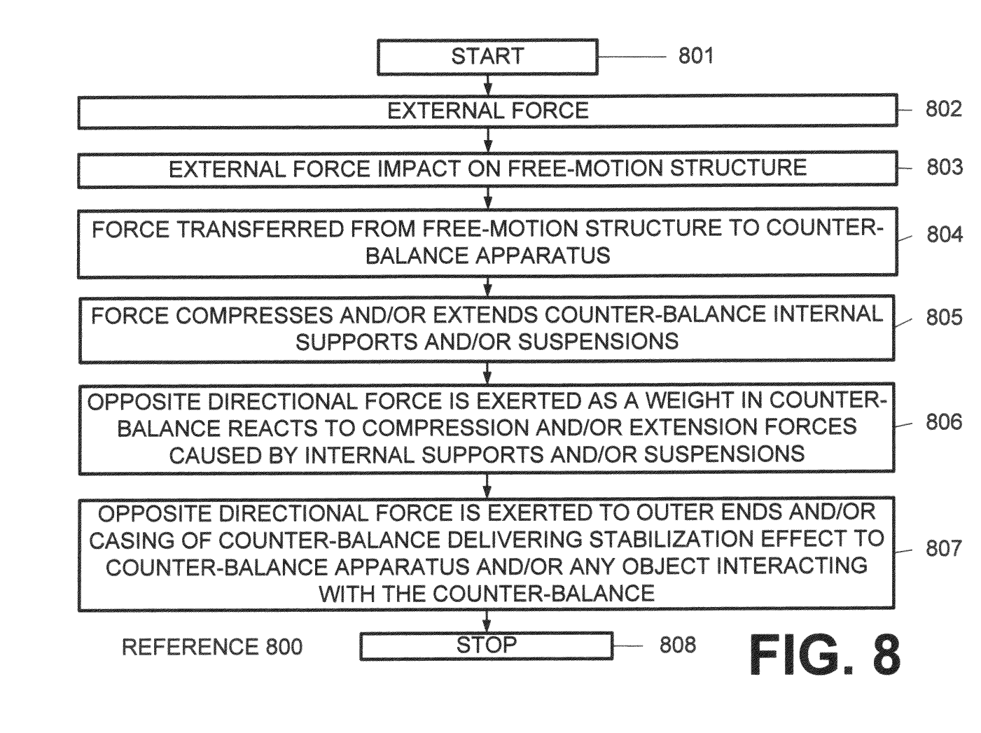

FIG. 8 illustrates a preferred embodiment of the apparatus and method of the present invention, which is designated generally by the reference number 800, in flow diagram form. With reference to FIG. 8, the apparatus and method 800 includes a starting point, 801, (hereinafter “Start 801”). The “Start 801” denotes the presence of any and/or all of the various parameters, conditions, substances, environments, and/or events for providing the various functionalities, operations, and/or services described herein as being provided by the apparatus 800. With reference to FIG. 8, the apparatus and method 800 includes the presence and/or action of an external force, 802, (hereinafter “External Force 802”) of an external force, existing externally either to the counter-balance, and/or the counter-balance in conjunction with an object and/or implementation characterized by free-motion. With reference to FIG. 8, the apparatus and method 800 includes an amount of an external force applied an object, and/or and object in association with the counter-balance, and/or in an implementation characterized by free-motion, 803, (hereinafter “External Impact 803”. Wherein the preferred embodiment of the apparatus and method of the present invention may or may not, depending on the application and/or construction, have the subject object and the counter-balance existing as a unified and/or integrated structure. With reference to FIG. 8, the apparatus and method 800 includes an amount of an external force transferred to the counter-balance, and/or the counter-balance in association with an object and/or an implementation characterized by free-motion, 804, (hereinafter “Transfer Force 804”. With reference to FIG. 8, the apparatus and method 800 includes an amount of an external force transferred to the counter-balance and effecting a compression and/or extension of supports and/or suspensions of the counter-balance, 805, (hereinafter “Compression and/or Extension 805”. With reference to FIG. 8, the apparatus and method 800 includes an amount of force associated with compression and or extension effects an opposing force from the weight and/or weights contained in the counter-balance on the supports and/or suspensions of the counter-balance, 806, (hereinafter “Opposing Compression and/or Extension 806”). With reference to FIG. 8, the apparatus and method 800 includes an amount of force transferred from the counter-balance, and/or to an object associated with the counter-balance and/or to an implementation characterized by free-motion in association with the counter balance, 807, (hereinafter “Stabilizing Force 807”. With reference to FIG. 8, the apparatus and method 800 includes a finish point, 808, (hereinafter “Stop 808”). The “Stop 808” denotes the improved stabilized state of the object that is subject to the stabilization effects of the counter-balance.

In yet another preferred embodiment, the present invention may be constructed in various materials, sizes, weights, shapes, motion paths, suspensions and/or support configurations in order to enable a multitude of counter-balance force effects. Moreover, the materials used in various constructions may vary in order to ensure that a certain type of construction is best suited for a particular purpose.

In this manner, a preferred embodiment of the apparatus and method of the present invention may be constructed with, and/or used in a construction comprising, one or more, any and/or all, in an combination of, but not limited to, the following materials, substances and forces; elements, chemical elements, periodical elements, proteins, amino acids, chemicals, compounds, organic compounds, inorganic compounds, pure substances, chemical substances, non-stoichiometric compounds, atoms, atomic particles, sub-atomic particles, energy, waves, magnetism, bonds, gravitational forces, biomaterials, carbon-based substances, wood, non-carbon-based substances, carbon, silica, metal alloys, iron, steel, stainless steel, cast iron, tool steel, alloy steels, low, mid and high carbon steels, chromium, nickel and molybdenum to carbon steels, stainless steel, aluminum, titanium, copper, magnesium, copper alloys, polymers, polyethylene, polypropylene, PVC (polyvinyl-chloride), polystyrene, nylons, polyesters, acrylics, polyurethanes, and polycarbonates, ceramics, resin, plasticizers, Medium-Density Polyethylene, Ultra-high Molecular Weight Polyethylene, composite materials, macroscopic phases, plastics, thermoplastic matrix, acrylonitrile-butadiene-styrene (ABS), calcium carbonate chalk, talc, glass fibers, carbon fibers, atomic bonds, ionic crystals, covalent crystals, metals, intermetallics, semiconductors, polymers, composite materials, vitreous materials, castings, rollings, weldings, ion implantations, crystals, crystal growths, thin-film depositions, sinterings, glass, fiberglass, and/or any substance that may be characterized by and/or identified by, but not limited to, the following analytical techniques; electron microscopy, x-ray diffraction, calorimetry, nuclear microscopy (HEFIB), Rutherford backscattering, neutron diffraction, small-angle X-ray scattering (SAXS).

In this manner, a preferred embodiment of the apparatus and method of the present invention may be utilized in a construction with any of, and/or any combination of, but not limited to, any motion through space defined by the following motion types; translatory motion (rectilinear motion, curvilinear motion), rotatory motion, and vibratory motion (simple pendulum).

In this manner, a preferred embodiment of the apparatus and method of the present invention may be utilized in a construction with any of, and/or any combination of, but not limited to, the following shapes; helix, lorenz attractor, Bézier triangle, ApBqCr vectors, hyperplane, möbius strip, platonic solid, dodecahedron, hexahedron (cube), icosahedron, octahedron, tetrahedron, torus (doughnut), quadric, cone, cylinder, ellipsoid, spheroid, sphere, hyperboloid, paraboloid, sphere, Klein bottle, Real projective plane, duocylinder, hypersphere, polychoron, hecatonicosachoron, hexacosichoron, hexadecachoron, icositetrachoron, pentachoron (simplex), tesseract, spherical cone, regular 5-polytopes [5-dimensional simplex, 5-dimensional cross-polytope, 5-dimensional hypercube (5-measure polytope)], Apollonian gasket, Cantor set, Dragon curve, Koch snowflake, Lévy C curve, Lyapunov fractal, Mandelbrot set, Sierpinski carpet, Peano curve, Sierpinski triangle, and Wormhole.

In this manner, a preferred embodiment of the apparatus and method of the present invention may be utilized in a construction with any of, and/or any combination of, but not limited to the following suspensions and supports; torsion pendulum, torsional harmonic oscillators, torsion bars, torsion spring, helical torsion spring, spring, balance spring, D'Arsonval movements, tiny torsion springs such as, but not limited to, those used in digital micromirror device chips, coiled torsion springs, a watch mechanism, a twisting mechanism, bending mechanism, stretching mechanism, an elastic mechanism, a flexible mechanism, a inflexible mechanism, a rigid mechanism, a mechanism that stores mechanical energy when twisted/turned/compressed/stretched/manipulated, a torsion bar, which may be comprised of, but not limited to, metal, rubber, non-metal, or non-rubber, natural, man-made substances, a torsion fiber, which may be comprised of, but not limited to, silk, glass, quartz, nano tubes, bucky balls, structural beams, ductile materials, structural element capable of withstanding load, structural element capable of resisting bending, structural elements capable of carrying vertical and/or horizontal and/or diagonal gravitational forces and/or other forces, structural compression members, cantilevers, deflectors, structures defined by elasticity, steel beams, joists, I-beams, thin-shell structures, trusses, tubes, columns, tension, compression arch, a supporting and/or suspending construction whose supporting and/or suspension properties can be explained by its elastic modulus (slope of its stress-strain curve in the elastic deformation region), supports or suspensions comprised of, but not limited to lasers, levers, energy waves, light waves, wave energy, quantum energy, gravitational energy, chemical energy, radiation energy, electromagnetic energy, electric energy, magnetic energy, wind energy, tidal energy, geologic forces, atmospheric pressure, barometric pressure, temperature related force, light energy, heat energy, bonding forces, separating forces, hydraulics, air pressure systems, a helical torsion spring, and/or coils, which may be comprise of, but not limited to, metal rod, wire, and/or suspensions and supports subject to, but limited to, bending stresses, torsional stresses, twisting stresses, stretching stresses, compression stresses, rotational stresses, movement stresses, motion path stresses, inertia stresses, quantum stresses, gravitational stresses, chemical stresses, radiation stresses, electromagnetic stresses, energy stresses, wind stresses, tidal stresses, wave stresses, geological stresses, atmospheric stresses, barometric stresses, temperature stresses, light stresses, heat stresses, force stresses, optical stresses, magnetic stresses, electric stresses, pressure stresses, pulling stresses, flexing stresses, bonding stresses, gravitational stresses, laser stress, lever stresses, in-plane forces, plane stress, flexural deformations, shear stresses, and tensile stresses.

In another preferred embodiment, the present invention may be constructed as an apparatus in various sizes to in order to enable a multitude of uses. By example, the device may be constructed at the particle level, atomic level or molecular in order to affect the movement and effects of external forces on, but not limited to, sub-atomic structures, atomic structures, and/or molecular structures, waves, radiation, as might appear in nano devices, and/or energy. Or, it may be the case that the apparatus and method are configured on the very small visible scale to be placed in other manufactured goods or structures such as, but not limited to, a sub-strata element, and/or applied coatings. Or, it may be the case that the apparatus and method are configured on the scale in which the human body might interact directly with the apparatus, such as, but not limited to, the case might be with a counter-balance used by athletes either in the instance where it is fixed in or to another piece of athletic equipment and/or held freely in the hands. Or, it may be the case that the apparatus and method are configured on the medium-to-large scale in which a vehicle may have the counter-balance fixed within and/or to its structure. Or, it may be the case that the apparatus and method are configured on the large scale in which a large building, tower, or bridge may have the counter-balance and/or multiple-counter balances fixed to and/or assembled within its construction.

In yet another preferred embodiment, the present invention may be constructed as an apparatus with varying volumes in order to effectuate a multitude of counter-balance effects, such as but not limited to its counter-balance effects in various mediums such as liquids, gases, plasmas, or solids. Or, it may be the case that the apparatus and method are configured in a manner that permits reactive, proactive, or dynamic changes to its volume.

In still another preferred embodiment, the present invention may be configured as an apparatus and method with varying weights, mass, or weight to volume ratios, or weighting configurations, or mass to volume ratios, or mass configurations, in order to effectuate a multitude of counter-balance effects, such as but not limited to its counter-balance effects at various altitudes and/or suspensions, and/or environments of varying densities. Or, it may be the case that the apparatus and method are configured in a manner that permits reactive, proactive, or dynamic changes to its weight.

In another preferred embodiment, the present invention may be configured as an apparatus and method with various and/or multiple suspension and/or support configurations in order to effectuate a multitude of counter-balance effects, such as but not limited to its counter-balance effects in response to varying directional forces and/or motion paths. Or, it may be the case that the apparatus is constructed in a manner that permits reactive, proactive, or dynamic changes to its various suspension and/or support configurations.

In yet another preferred embodiment, the present invention may be constructed as an apparatus with various intended motion paths and/or intentionally random motion paths in order to effectuate a multitude of counter-balance effects, such as but not limited to its counter-balance effects in response to external forces that may be encountered at predetermined and/or random intervals. Or, it may be the case that the apparatus and method are configured in a manner that permits reactive, proactive, or dynamic changes to its motion path, paths, and or intentionally random motion paths. In such a preferred embodiment, the present invention may be constructed with artificial intelligence, computational capabilities, algorithms, processors, memory devices, storage devices, communications devices, and mechanics necessary to effectuate such pre-determined and/or reactive and/or learned counter-balance effects.

In still another preferred embodiment, the present invention may be constructed as an apparatus with various materials and/or multiple materials in order to effectuate a multitude of counter-balance effects, such as but not limited to its counter-balance effects in response to external forces that may be encountered at in response to a variety of substances and/or energies such as but not limited to various levels of friction, viscosity, electromagnetism, heat, light, radiation, forces of energy, inertia, forces of motion, and/or gravity. Or, it may be the case that the apparatus and method are configured in a manner that permits reactive, proactive, or dynamic changes to its materials. In such a preferred embodiment, the materials employed in the counter-balance may be, but are not limited to, solids, liquids, gasses, plasmas, building material, any material for a construction purpose, naturally occurring substances, man-made materials, natural materials, metal, wood, plastics, rubber, organic, inorganic, alloys, porous, non-porous, fabrics, foam, mud, clay, ceramics, rock, thatch, brush, ice, wood, brick, block, concrete, metal, glass, plastic, foam, cement composites, natural materials, synthetic materials, plastics, petroleum based substances, paints, stone, fibrous plants, cloth, skins, wattle, daub, fabric, tensile architectures, synthetic fabrics, fabric membranes, steel cables, cement, cement concrete, steel, metal alloys, iron, aluminum alloys, brass, titanium, chrome, gold, silver, mortar, cement composites, cement bonded composites, elemental compositions, sub-atomic compositions, atomic compositions, energy compositions, chemical compositions, biological compositions, and nuclear compositions.

In another preferred embodiment, the present invention may be constructed as an apparatus composed of multiple counter-balances acting either in concert and/or independently in order to effectuate a multitude of counter-balance effects, such as but not limited to its counter-balance effects in flexible materials, coatings, substrates, laminates, garments, devices, equipment, machines, edifices, and/or vehicles. Or, it may be the case that the apparatus and method are configured in a manner that permits reactive, proactive, or dynamic changes to its numbers of instances of occurrence.

In yet another preferred embodiment, the present invention may be constructed as an apparatus with the ability to make changes and/or augment any one of the physical parameters that would alter the effect of the counter-balance such as but not limited to material, size, volume, weight, suspension and/or support configurations, motion paths, and/or quantities, and/or any ratios of two or more of such variables. Or, it may be the case that the apparatus and method are configured in a manner that permits reactive, proactive, or dynamic changes to such physical parameters.

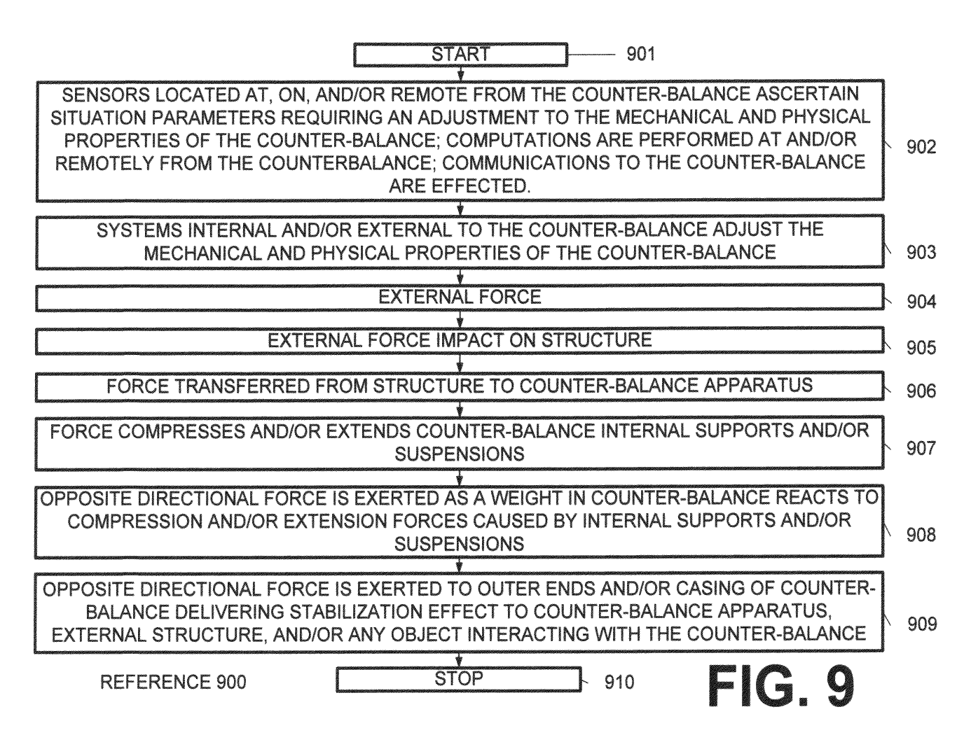

FIG. 9 illustrates a preferred embodiment of the apparatus and method of the present invention, which is designated generally by the reference number 900, in flow diagram form. With reference to FIG. 9, the apparatus and method 900 includes a starting point, 901, (hereinafter “Start 901”). The “Start 901” denotes the presence of any and/or all of the various parameters, conditions, substances, environments, and/or events for providing the various functionalities, operations, and/or services described herein as being provided by the apparatus 900. With reference to FIG. 9, the apparatus and method 900 includes sensors located at, on, and/or remote from the counter-balance ascertaining situational parameters requiring an adjustment to the mechanical and physical properties of the counter-balance wherein computations are performed at and/or remotely from the counterbalance wherein communications to counter-balance are effected, (hereinafter “Sensor-Compute-Communicate 902”). With reference to FIG. 9, the apparatus and method 900 includes systems internal and/or external to the counter-balance adjusting the mechanical and physical properties of the counter-balance, (hereinafter “Adjust 903”). With reference to FIG. 9, the apparatus and method 900 includes the presence and/or action of an external force, 904, (hereinafter “External Force 904”), existing externally either to the counter-balance, and/or a structure in association with the counter-balance, and/or the counter-balance in conjunction with an object and/or implementation characterized by free-motion. With reference to FIG. 9, the apparatus and method 900 includes an amount of an external force applied a structure in association with the counter-balance, and/or in an implementation characterized by free-motion, 905, (hereinafter “External Impact 905”. Wherein the preferred embodiment of the apparatus and method of the present invention may or may not, depending on the application and/or construction, have the subject object and the counter-balance existing as a unified and/or integrated structure. With reference to FIG. 9, the apparatus and method 900 includes an amount of an external force transferred to the counter-balance, and/or the counter-balance in association with an object and/or an implementation characterized by free-motion, 906, (hereinafter “Transfer Force 906”. With reference to FIG. 9, the apparatus and method 900 includes an amount of an external force transferred to the counter-balance and effecting a compression and/or extension of supports and/or suspensions of the counter-balance, 907, (hereinafter “Compression and/or Extension 907”. With reference to FIG. 9, the apparatus and method 900 includes an amount of force associated with compression and or extension effects an opposing force from the weight and/or weights contained in the counter-balance on the supports and/or suspensions of the counter-balance, 908, (hereinafter “Opposing Compression and/or Extension 908”). With reference to FIG. 9, the apparatus and method 900 includes an amount of force transferred from the counter-balance, and/or to an object associated with the counter-balance and/or to an implementation characterized by free-motion in association with the counter balance, 909, (hereinafter “Stabilizing Force 909”. With reference to FIG. 9, the apparatus and method 900 includes a finish point, 910, (hereinafter “Stop 910”). The “Stop 910” denotes the improved stabilized state of the object that is subject to the stabilization effects of the counter-balance.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. A counter-balance apparatus, comprising:
a weight(s), wherein the weight(s) provides a resisting force when subjected to force originating externally to the apparatus;
a support(s) and/or suspension(s), wherein the support(s) and/or suspension(s) maintains the weight(s) position relative to the force per the direction, strength, and type of force, wherein the support(s) and/or suspension(s) transfer force to the weight(s), wherein the weights provide a resisting force, and wherein the support(s) and/or suspensions transfer the resisting force from the weight(s) in the opposing direction of the of the external force.

2. The apparatus of claim 1, wherein the weight(s), and/or support(s), and/or suspension(s) is an object with mass so as to provide the counter-balance effect without regard to the presence of gravity.

3. The apparatus of claim 1, further comprising:
a casing, wherein the casing serves as a container for the weight(s) and support(s) and/or suspension(s).

4. The apparatus of claim 1, further comprising:
a fastener(s), wherein the fastener(s) allow for the counter-balance to be fixed to a stationary and/or movable structure, wherein said structure may be either immobile with a fixed position, or moveable.

5. The apparatus of claim 1, further comprising:
a band(s), wherein the band(s) allow for the counter-balance to be secured to an object in free-motion.

6. The apparatus of claim 1, wherein the weight(s), and/or support(s), and/or suspension(s) is of the size of any of a particle, atom, molecule, sub-atomic structure, atomic structure, nano structure, very small visible scale structure, sub-strata structure, coating, hand-held structure, human-interfacing equipment structure, vehicle structure, and/or edifice structure.

7. The apparatus of claim 1, wherein the weight(s) and support(s) and/or suspension(s) is of any material, and/or volume, and/or weight, and/or mass, and/or motion path adequate for providing the counter-balance effect.

8. The apparatus of claim 1, wherein the medium in which the counter-balance may be used and/or materials from which it may be constructed is one or more of a liquid, gas, plasma, solid, particle(s), matter, or anti-matter.

9. The apparatus of claim 1, wherein the counter-balance employs, computational capabilities, algorithms, artificial intelligence, processors, memory devices, storage devices, communications devices, and mechanics necessary to effectuate such pre-determined, and/or proactive, and/or reactive, and/or learned counter-balance effects.

10. The apparatus of claim 1, wherein the weight(s), and/or support(s), and/or suspension(s), are configured in multiples greater than one in a single construct and for a single implementation.

11. A method for a counter-balance, which comprises:
providing a resistance to a force by employing a weight(s), wherein the weight(s) is subject to a force;
maintaining the weight(s) position relative to the force by employing a support(s) and/or suspension(s), with regard to the direction, strength, and type of force;
transferring a force external to the weight(s), and/or support(s), and/or suspension(s), through the support(s), and/or suspension(s), to the weight(s);
transferring the resisting force from the weight(s), through the support(s), and/or suspension(s), in the opposing direction of the external force.

12. The method of claim 11, further comprising the step of
providing a weight(s), and/or support(s), and/or suspension(s) with mass so as to provide the counter-balance effect without regard to the presence of gravity.

13. The method of claim 11, further comprising the step of:
encasing the counter-balance, so as to provide a container for the weight(s) and support(s) and/or suspension(s).

14. The method of claim 11, further comprising the step of:
providing a fastener(s), wherein the fastener(s) allow for the counter-balance to be fixed to a stationary and/or movable structure, wherein said structure may be either immobile with a fixed position, or moveable.

15. The method of claim 11, further comprising the step of:
providing a band(s), wherein the band(s) allow for the counter-balance to be secured to an object in free-motion.

16. The method of claim 11, wherein said weight(s), and/or support(s), and/or suspension(s) is of the size of any of a particle, atom, molecule, sub-atomic structure, atomic structure, nano structure, very small visible scale structure, sub-strata structure, coating, hand-held structure, human-interfacing equipment structure, vehicle structure, and/or edifice structure.

17. The method of claim 11, wherein the weight(s) and support(s) and/or suspension(s) is of any material, and/or volume, and/or weight, and/or mass, and/or motion path adequate for providing the counter-balance effect.

18. The method of claim 11, wherein the medium in which the counter-balance may be used and/or materials from which it may be constructed is one or more of a liquid, gas, plasma, solid, particle(s), matter, or anti-matter.

19. The method of claim 11, wherein the counter-balance employs, computational capabilities, algorithms, artificial intelligence, processors, memory devices, storage devices, communications devices, and mechanics necessary to effectuate such pre-determined, and/or proactive, and/or reactive, and/or learned counter-balance effects.

20. The method of claim 11, wherein the weight(s), and/or support(s), and/or suspension(s), are configured in multiples greater than one in a single construct and for a single implementation.
